(19) United States
(12) Patent Application Publication
(10) Pub. No.: US 2008/0238227 A1
(43) Pub. Date: Oct. 2, 2008

(54) Electric Motor

(75) Inventors: Achim Hawighorst, Buehlertal (DE); Matthias Koesters, Friesoythe (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/089,738

(22) PCT Filed: Sep. 19, 2006
(86) PCT No.: PCT/EP2006/066498

§ 371 Date: May 22, 2008

(30) Foreign Application Priority Data
Oct. 10, 2005 (DE) 10 2005 048 340.2

(51) Int. Cl. H02K 5/14

(52) U.S. Cl. 310/89; 310/245

(57) ABSTRACT

The present invention relates to a sliding-contact holder (8) for an electric motor, which has a cylindrical motor housing (1), a front housing cover (2), a rear housing base (3), a rotor shaft (4), a rotor (5), a commutator (6), a stator (7) and a sliding-contact holder (8). The sliding-contact holder (8) comprises at least two holder elements, which each bear at least one sliding contact (11). The two holder elements are inserted individually into the cylindrical motor housing (1). Owing to its design, the sliding-contact holder (8) saves on space and can easily be inserted into the motor housing (1).

### BACKGROUND OF THE INVENTION

The present invention relates to a sliding contact holder, an electric motor with such a sliding contact holder and a corresponding method for assembling an electric motor.

This type of sliding contact holder, this type of electric motor and this type of method for assembling an electric motor are described in DE 90 13 006 U1. The electric motor has a sliding contact holder, which is embodied as a single piece, i.e., the holder element on which the sliding contacts are attached is comprised of a single piece. When assembling the electric motor, first the rotor shaft, on which the rotor and commutator are attached, is inserted into the motor housing of the electric motor. Then the sliding contacts are slid over the commutator. In order to guarantee a good electric contract, it is necessary for the sliding contacts to press elastically against the commutator after they are inserted. Prior to inserting the sliding contact holder, the distance between the sliding contacts is therefore smaller than the diameter of the commutator. As a result, when the sliding contacts are being inserted, they must be pressed apart. This makes it more difficult to assemble the electric motor.

In contrast to this, the electric motor known from DE 198 58 233 A1 makes simple assembly possible. Its sliding contact holder is also embodied as a single piece. The sliding contacts attached to the sliding contact holder are embodied as hammer brushes. So-called wing aids, each forming a diagonal, are attached to the ends of the hammer brushes. The sliding contacts embodied as hammer brushes are also slid over the commutator after the rotor shaft with the rotor and commutator are inserted. In this case, the wing aids hit against the commutator. The winds aids make sure that the hammer brushes are spread apart. In other words, no additional external effect of force is required to press the hammer brushes apart. As a result, this facilitates assembly of the electric motor. However, the sliding contact holder requires a lot of room in the direction of the rotor shaft, because the sliding contacts must be movable in the direction of the rotor shaft. In addition, the wing aids project far into the motor housing. In addition, a special device is required just to insert the sliding contact holder.

### SUMMARY OF THE INVENTION

The objective underlying the present invention is creating a sliding contact holder that saves on space, which can be inserted simply into the motor housing, as well as an electric motor with such a sliding contact holder and a corresponding method for assembling an electric motor.

The objective underlying the invention is attained by a sliding contact holder comprised of at least two holder elements, each of which bears at least one sliding contact, an electric motor with a sliding contact holder comprised of at least two holder elements, each of which bears at least one sliding contact and a method for assembling an electric motor characterized in that in order to insert the sliding contact holder, first of all, a first holder element and then a second holder element are inserted.

A sliding contact holder in accordance with the invention has at least two sliding contacts, which touch the commutator. The sliding contact holder is comprised of at least two holder elements, each of which bears at least one sliding contact.

This type of sliding contact holder advantageously saves on space and is simple to insert into the motor housing. The saved space goes hand in hand with a corresponding reduction in weight and a savings of material costs. Beyond this, the lower weight produces a reduction in fuel consumption, if the sliding contact holder in accordance with the invention is used for an electric motor, which is installed in a motor vehicle. In this case, it must be taken into consideration that modern motor vehicles use a great number of electric motors for window lifters, sunroofs, seat adjusters, windshield wipers, etc.

The holder elements of the sliding contact holder are preferably embodied as half rings.

The embodiment of the holder elements as half rings makes possible simple fixation, simple installation and a good stability of the sliding contact holder.

In addition, the present invention relates to an electric motor with a with a cylindrical motor housing, a front housing cover, a rear housing base, a rotor shaft, a rotor, a commutator, a stator and a sliding contact holder. The cylindrical motor housing has a front housing opening, which is closed by the front housing cover, in whose center point a front shaft bearing is situated. A rear shaft bearing is situated in the center point of the rear housing base. The rotor shaft, on which the rotor and the commutator sit in a rotationally fixed manner, is rotatably mounted in the front and the rear shaft bearings. The stator runs along the inner wall of the cylindrical motor housing and surrounds the rotor. At least two sliding contacts that touch the commutator are attached to the sliding contact holder. The sliding contact holder is embodied in accordance with the invention.

In a preferred embodiment, a step, on which the contact holder rests, runs along the inner wall of the cylindrical motor housing.

In a development of the preferred embodiment, a step runs along the inner wall of the front housing cover so that the sliding contact holder is fixed between the step along the inner wall of the cylindrical motor housing and the step along the inner wall of the front housing cover.

In a preferred embodiment at least one of the holder elements has a recess, which points towards the inner wall of the motor housing, and the inner wall of the motor housing has at least one projection, which engages in the at least one recess.

As a result, the sliding contact holder is advantageously secured against rotations around the rotor shaft.

Furthermore, the present invention relates to a method for assembling an electric motor in accordance with the invention. The method in accordance with the invention includes the following steps: insertion of the rotor shaft, insertion of the sliding contact holder, and insertion of the front housing cover.

In this case, in order to insert the sliding contact holder, first of all, a first holder element and then a second holder element are inserted.

Advantageously, it is not necessary to press the sliding contacts apart when inserting the sliding contact holder. A special device is not required just to insert the sliding contact holder.

### BRIEF DESCRIPTION OF THE DRAWINGS

The invention will be described in greater detail in the following making reference to the drawings. The drawings show:

FIG. 1A longitudinal section of an electric motor;

FIG. 2 The sliding contact holder from FIG. 1; and

FIG. 3 The process of inserting a holder element.

### DETAILED DESCRIPTION

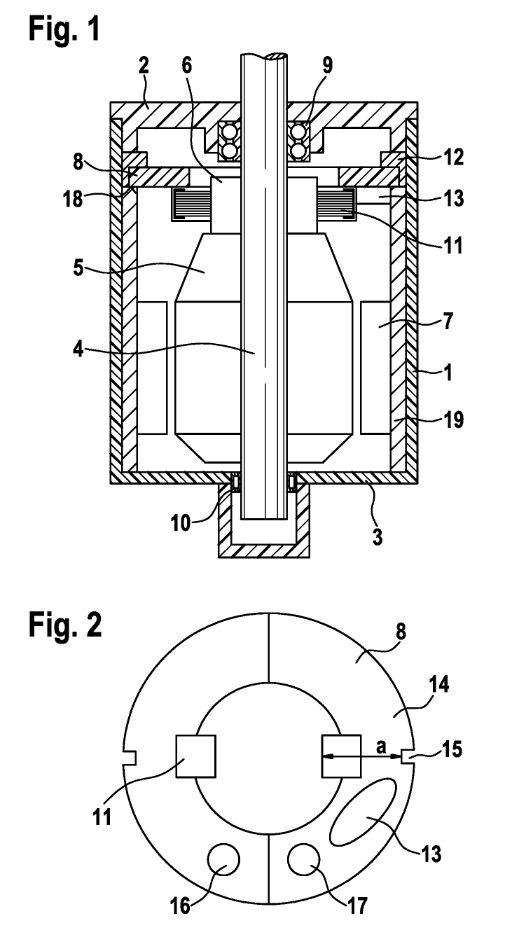

FIG. 1 depicts a longitudinal section through an electric motor, like those that can be used in particular for an automobile windshield wiper. The electric motor has a cylindrical motor housing 1, a front housing cover 2, a rear housing base 3, a rotor shaft 4, a rotor 5, a commutator 6, a stator 7, and a sliding contact holder 8.

A front housing opening of the motor housing is closed by the front housing cover 2. The housing base 3 is embodied as a rear housing cover 3, which closes a rear housing opening.

Situated in the center points of the front and rear housing cover 3 are a front and rear shaft bearing 9, 10 respectively. Alternatively, the rear housing base 3 and the cylindrical motor housing 1 also be embodied as a single piece as a pole pot. This type of pole pot as well as the front housing cover 3 can be fabricated of plastic, which makes a substantial reduction in weight possible as compared with a metal material.

A pole ring 19 made of a magnetic material runs along the inner side of the cylindrical motor housing 1. The stator 7 sits directly on the inner side of the pole ring 19. It is composed of a permanent magnet and produces the magnetization of the pole ring 19. The magnetic effect of the permanent magnet 7 is further reinforced by the pole ring 19.

The rotor shaft 4 is rotatably mounted in the front and rear shaft bearings 9, 10 and runs through a center axis of the rotor 5 and a center axis of the commutator 6. The rotor 5 and the commutator 6 are fastened to the rotor shaft 4 so that the rotor 5 and the commutator 6 rotate along with the rotor shaft 4 in the cylindrical motor housing 1. The stator 7 surrounds the rotor 5.

Attached to the sliding contact holder 8, which surrounds the commutator 6, are two sliding contacts 11, which press elastically against the commutator 6 under the effect of a spring. Carbon brushes are used as sliding contacts 11 as a rule. The use of hammer brushes as well as cartridge-type brushes is also possible. In this case, the hammer brushes can be movable in one plane, which the rotor shaft 4 intersects perpendicularly. This arrangement of the hammer brushes allows space to be saved in the direction of the rotor shaft 1.

Two electrical connections 12 for the sliding contacts 11 are attached to the inner wall of the motor housing 1. The electrical connections 12 for the sliding contacts 11 engage in recesses 15 (see FIG. 2) of the sliding contact holder 8. As a result, the electrical connections 12 are not just used to supply power, but also for fixing the sliding contact holder 8 against rotations in the plane perpendicular to the rotor shaft 4.

Alternatively (not shown), the sliding contact holder 8 can be secured against rotations in the plane perpendicular to the rotor shaft 4 also with the aid of projections, which engage in recesses on the inner side of the motor housing. The sliding contact holder 8 can also be fixed using projections, which are not identical to the electrical connections 12 and engage in recesses in the sliding contact holder 8.

The sliding contact holder 8 rests on a step 18, which is formed by the front end of the pole ring 19. A step, which runs along the inner wall of the front housing cover 2, presses from the front on the sliding contact holder 8. This step is concealed in FIG. 1 by the electrical connections 12. The outer edge of the front housing cover 2 actually ends first at the sliding contact holder 8. The sliding contact holder 8 is therefore securely fixed in the direction of the rotor shaft 4 as well as perpendicularly to said shaft.

A partially concealed thermal switch is identified by reference number 13. If the mobility of the rotor 4 is greatly impaired, the electrical windings on the rotor 4 heat up. This causes the thermal switch 13 to shut off, which interrupts the electrical flow of current. Igniting of the electric motor or deformation of the plastic parts of the electric motor due to excessive heating can be safely avoided as a result.

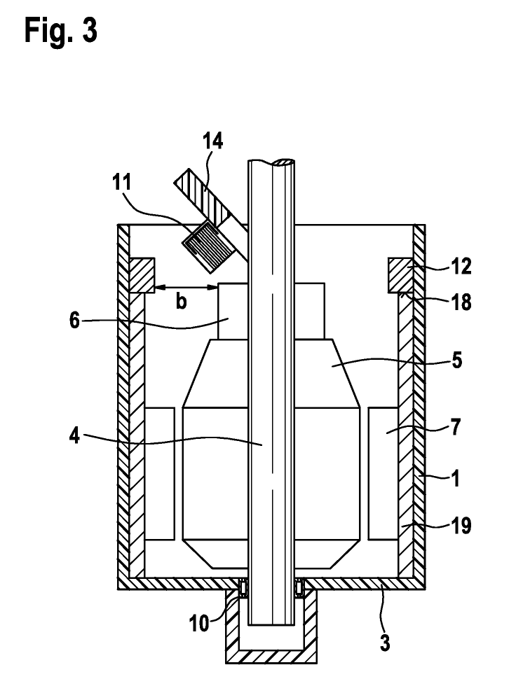

FIG. 2 depicts the sliding contact holder 8 from FIG. 1. It is comprised of two holder elements 14, which are embodied as separate half rings 14 that abut one another in such a way that they form a complete ring. The embodiment of the sliding contact holder 8 as two separate half rings 14 makes simple fixation possible, as was described with reference to FIG. 1. Good stability of the sliding contact holder 8 is guaranteed at the same time. The use of more than two holder elements 14 would only reduce the stability of the sliding contact holder 8. The use of two holder elements 14 is also especially favorable for installing the holder elements 14, which will be described with reference to FIG. 3. The use of more than two holder elements 14 would require an additional fixation measure since the holder elements 14 would tend to tip into the motor housing 1 with the end that is opposite from the one that rests on the step 18.

Recesses 15, into which the electrical connections 12 from FIG. 1 engage, are located externally on the holder elements 14 across from the sliding contacts 11. The thermal switch 13 is attached on the underside of the sliding contact holder 8. Electronic components 16 and 17 are also attached on the underside of the sliding contact holder 8. These electronic components are concealed by the commutator in FIG. 1. The electronic components 16 and 17 can be passive components such as resistors and capacitors, but also active components like transistors. The components 16 and 17 can also represent a complete set of control electronics, which is thus housed on the sliding contact holder 8. Plastic is preferably used as the material for the holder elements 14. Then both the thermal switch 13 as well as the electronic components 16 and 17 can be accommodated in plastic pockets, which are sprayed on the holder elements 14.

FIG. 3 illustrates how the holder element 14 is inserted into the motor housing 1 after the rotor shaft 4, on which the rotor 5 and the commutator 6 are attached, was inserted into the motor housing 1. To begin with, the holder element 14 is aligned in such a way that the edge at which the two holder elements 14 abut one another in an assembled state (see FIG. 2) points toward the commutator 6. Then the side along the arrow in FIG. 3 that points to the outside of the motor housing 1 is swiveled toward the motor housing 1. During this swiveling action, the contact surface of the sliding contacts 11 hits against the commutator 6 and is thereby slid back. Because of the swiveling action, it is possible to insert the holder element 14 into the motor housing 1 even though Distance a between the recess 15 and the inner contact surface of the sliding contact 11 (see FIG. 2) is greater than Distance b between the electrical connection 12 and the commutator 6, when the holder element 14 is not installed in the motor housing 1. Finally, the front housing cover 2 is also inserted.

1. Sliding contact holder for an electric motor with a cylindrical motor housing (1), a front housing cover (2), a rear housing base (3), a rotor shaft (4), a rotor (5), a commutator (6), a stator (7) and a sliding contact holder (8), wherein the cylindrical motor housing (1) has a front housing opening, which is closed by the front housing cover (2), in whose center point a front shaft bearing (9) is situated, wherein a rear shaft bearing (10) is situated in the center point of the rear housing base (3), wherein the rotor shaft (4), on which the rotor (5) and the commutator (6) sit in a rotationally fixed manner, is rotatably mounted in the front and the rear shaft bearings (9, 10), wherein the stator (7) runs along the inner wall of the cylindrical motor housing (1) and surrounds the rotor (5), wherein at least two sliding contacts (11) that touch the commutator (6) are attached to the sliding contact holder (8), characterized in that the sliding contact holder (8) is comprised of at least two holder elements (14), each of which bears at least one sliding contact (11).

2. Sliding contact holder according to claim 1, characterized in that the holder elements (14) are embodied as half rings.

3. Electric motor with a cylindrical motor housing (1), a front housing cover (2), a rear housing base (3), a rotor shaft (4), a rotor (5), a commutator (6), a stator (7) and a sliding contact holder (8), wherein the cylindrical motor housing (1) has a front housing opening, which is closed by the front housing cover (2), in whose center point a front shaft bearing (9) is situated, wherein a rear shaft bearing (10) is situated in the center point of the rear housing base (3), wherein the rotor shaft (4), on which the rotor (5) and the commutator (6) sit in a rotationally fixed manner, is rotatably mounted in the front and the rear shaft bearings (9, 10), wherein the stator (7) runs along the inner wall of the cylindrical motor housing (1) and surrounds the rotor (5), wherein at least two sliding contacts (11) that touch the commutator (6) are attached to the sliding contact holder (8), characterized in that the sliding contact holder (8) is comprised of at least two holder elements (14), each of which bears at least one sliding contact (11).

4. Electric motor according to claim 3, characterized in that a step (18) runs along the inner wall of the cylindrical motor housing (1), and that the sliding contact holder (8) rests on the step (18).

5. Electric motor according to claim 4, characterized in that a step runs along the inner wall of the front housing cover (2) so that the sliding contact holder (8) is fixed between the step (18) along the inner wall of the cylindrical motor housing (1) and the step along the inner wall of the front housing cover (2).

6. Electric motor according to claim 3, characterized in that at least one of the holder elements (14) has a recess (15), which points towards the inner wall of the motor housing (1), and that the inner wall of the motor housing (1) has at least one projection (12), which engages in the at least one recess (15).

7. Electric motor according to claim 3, characterized in that the holder elements (14) are embodied as half rings.

8. Method for assembling an electric motor with a cylindrical motor housing (1), a front housing cover (2), a rear housing base (3), a rotor shaft (4), a rotor (5), a commutator (6), a stator (7) and a sliding contact holder (8), wherein the cylindrical motor housing (1) has a front housing opening, which is closed by the front housing cover (2), in whose center point a front shaft bearing (9) is situated, wherein a rear shaft bearing (10) is situated in the center point of the rear housing base (3), wherein the rotor shaft (4), on which the rotor (5) and the commutator (6) sit in a rotationally fixed manner, is rotatably mounted in the front and the rear shaft bearings (9, 10), wherein the stator (7) runs along the inner wall of the cylindrical motor housing (1) and surrounds the rotor (5), wherein at least two sliding contacts (11) that touch the commutator (6) are attached to the sliding contact holder (8), having the following steps: insertion of the rotor shaft (4), insertion of the sliding contact holder (8), and insertion of the front housing cover (2), characterized in that in order to insert the sliding contact holder (8), first of all, a first holder element (14) and then a second holder element (14) are inserted.

9. Electric motor according to claim 4, characterized in that at least one of the holder elements (14) has a recess (15), which points towards the inner wall of the motor housing (1), and that the inner wall of the motor housing (1) has at least one projection (12), which engages in the at least one recess (15).

10. Electric motor according to claim 5, characterized in that at least one of the holder elements (14) has a recess (15), which points towards the inner wall of the motor housing (1), and that the inner wall of the motor housing (1) has at least one projection (12), which engages in the at least one recess (15).

11. Electric motor according to claim 4, characterized in that the holder elements (14) are embodied as half rings.

12. Electric motor according to claim 5, characterized in that the holder elements (14) are embodied as half rings.

13. Electric motor according to claim 6, characterized in that the holder elements (14) are embodied as half rings.

14. Electric motor according to claim 9, characterized in that the holder elements (14) are embodied as half rings.

15. Electric motor according to claim 10, characterized in that the holder elements (14) are embodied as half rings.
